(19) United States
(12) Patent Application Publication
(10) Pub. No.: US 2008/0241422 A1
(43) Pub. Date: Oct. 2, 2008

(54) METHOD FOR AEROSOL SYNTHESIS OF CARBON NANOSTRUCTURE UNDER ATMOSPHERIC PRESSURE

(75) Inventors: Jung-Ho Hwang, Seoul (KR); Jeong-Hoon Byeon, Chungcheongnam-do (KR); Byung-Ju Ko, Seoul (KR); Jae-Hong Park, Seoul (KR); Ki-Young Yoon, Seoul (KR)

Correspondence Address: RABIN & Berdo, PC, 1101 14TH STREET, NW, SUITE 500, WASHINGTON, DC, 20005, US

(73) Assignee: Industry-Academic Cooperation Foundation, Yonsei University, Seoul (KR)

(21) Appl. No.: 11/954,161

(22) Filed: Dec. 11, 2007

(30) Foreign Application Priority Data
Jan. 5, 2007 (KR) 10-2007-0001630

(51) Int. Cl. H05H 1/48

(52) U.S. Cl. 427/580

(57) ABSTRACT

The present invention relates to a method for the aerosol synthesis of carbon nanostructures under atmospheric pressure comprising a spark generation step of generating a spark between a graphite electrode made of carbon and a metal electrode made of a catalytic metal inducing the graphitization of carbon and vaporizing the carbon component of the graphite electrode and the metal component of the metal electrode utilizing the heat produced by the spark, thereby generating carbon vapor and metal vapor; and a carbon nanostructure generation step of cooling and condensing the carbon vapor and the metal vapor to form a graphitic carbon layer and catalytic metal particles and generating carbon nanostructures in which the graphitic carbon layer grows on the surface of the catalytic metal particles and covers the catalytic metal particles.

### BACKGROUND OF THE INVENTION

1. Field of the Invention

The present invention relates to a method for the aerosol synthesis of carbon nanostructures under atmospheric pressure, more particularly to a method for the aerosol synthesis of carbon nanostructures under atmospheric pressure by which carbon nanostructures are grown in aerosol state using spark generation between a graphite electrode and a metal electrode under atmospheric pressure.

2. Discussion of the Background

Carbon nanostructures are essential materials in the nanotechnology, which are drawing attention as electronic/magnetic materials and functional materials. Representative examples are carbon nanotube (CNT), carbon nanofiber, carbon nanoribbon, carbon nanoonion (CNO), carbon nanorod (CNR), and so forth.

In general, the carbon nanostructures including the carbon nanotube (CNT), carbon nanofiber (CNF), etc. are prepared by such methods as arc discharge, catalytic chemical vapor deposition (CCVD), flame synthesis, and so forth.

However, the conventional process for the synthesis of carbon nanostructures is batch type, in general, and thus is accompanied by a delivery problem. Further, a specific critical reaction condition is required for the synthesis of the carbon nanostructures and various hazardous substances are produced through the involved liquid-phase chemical process. In addition to the environmental problems, the cost is high because of large energy consumption.

### SUMMARY OF THE INVENTION

Accordingly, an object of the present invention is to provide a method for the synthesis of carbon nanostructures under atmospheric pressure, by which carbon nanostructures generated in aerosol state using spark generation, providing easiness in synthesis and delivery, environmental friendliness and reduced energy consumption.

In order to attain the aforesaid object, the present invention provides a method for the synthesis of carbon nanostructures under atmospheric pressure comprising a spark discharge step of generating a spark between a graphite electrode made of carbon and a metal electrode made of a catalytic metal inducing the graphitization of carbon and vaporizing the carbon component of the graphite electrode and the metal component of the metal electrode utilizing the heat produced by the spark, thereby generating carbon vapor and metal vapor; and a carbon nanostructure generation step of cooling and condensing the carbon vapor and the metal vapor to form a graphitic carbon layer and catalytic metal particles and generating carbon nanostructures in which the graphitic carbon layer grows on the surface of the catalytic metal particles and covers the catalytic metal particles.

### BRIEF DESCRIPTION OF THE DRAWINGS

FIG. 1 is a flow chart of the method for the synthesis of carbon nanostructures under atmospheric pressure according to an embodiment of the present invention.

FIG. 2 is a schematic view of the spark generation step and the carbon nanostructure generation step illustrated in FIG. 1.

FIGS. 3a to 3c are cross-sectional views of the carbon nanostructures synthesized according to the method illustrated in FIG. 1.

FIG. 4 is a schematic view of an embodiment of the aggregate separation step illustrated in FIG. 1.

FIG. 5 is a schematic view of an embodiment of the collection step illustrated in FIG. 1.

FIG. 6 is a schematic view of another embodiment of the spark generation step illustrated in FIG. 1.

### DESCRIPTION OF THE PREFERRED EMBODIMENTS

A more complete appreciation of the invention and many of the attendant advantages thereof will be readily obtained as the same becomes better understood by reference to the following detailed description when considered in connection with the accompanying figures. The terms and words used in this specification and claims shall not be understood as limited to the lexical meaning. Based on the principle that an inventor can adequately define terms to best describe his/her invention, the terms and words shall be interpreted as conforming to the technical spirit of the present invention.

Accordingly, the examples and drawings disclosed in this specification are only exemplary ones and there may be various equivalents and modifications at the time of the application for patent of this invention.

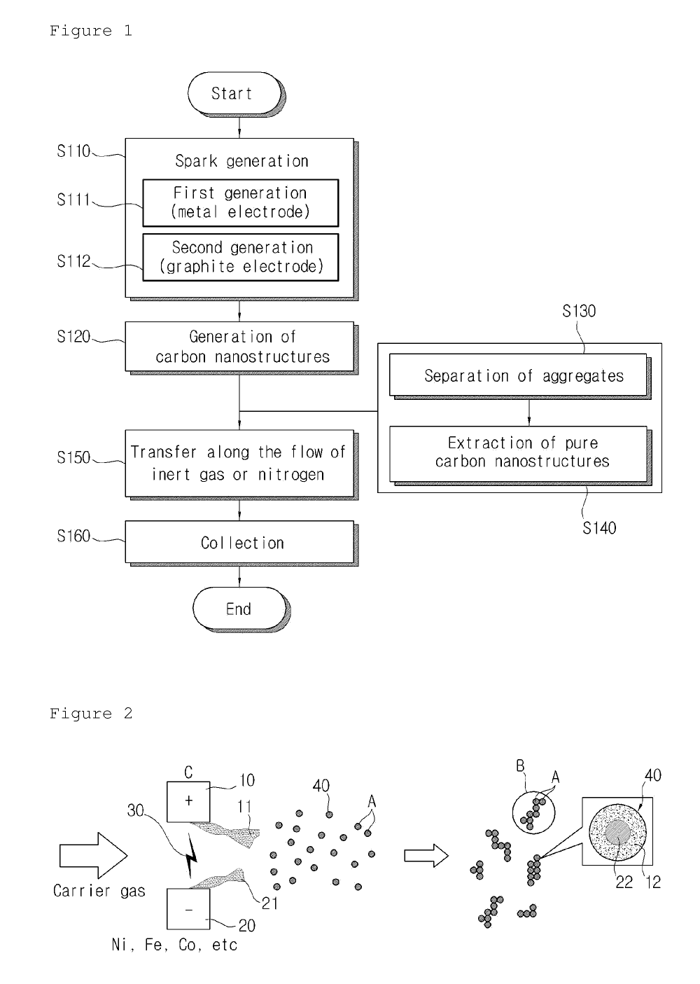

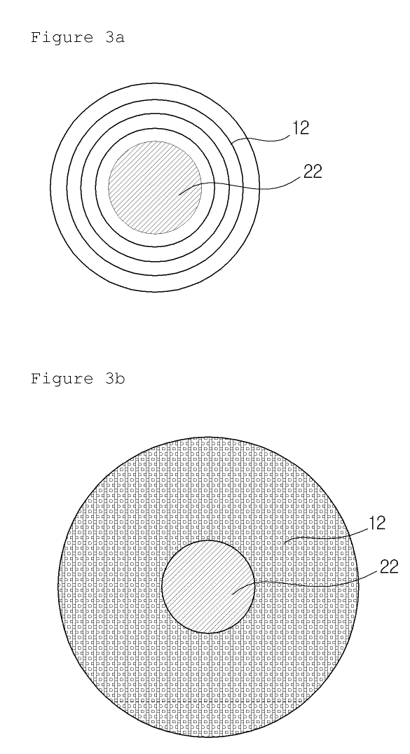

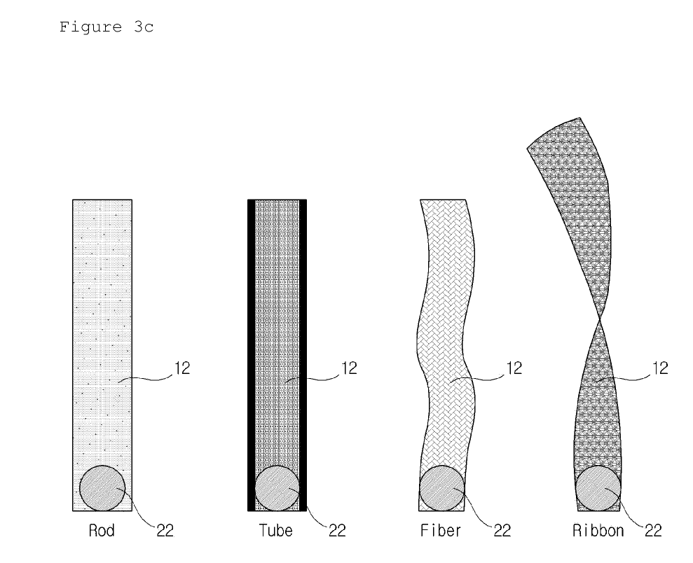

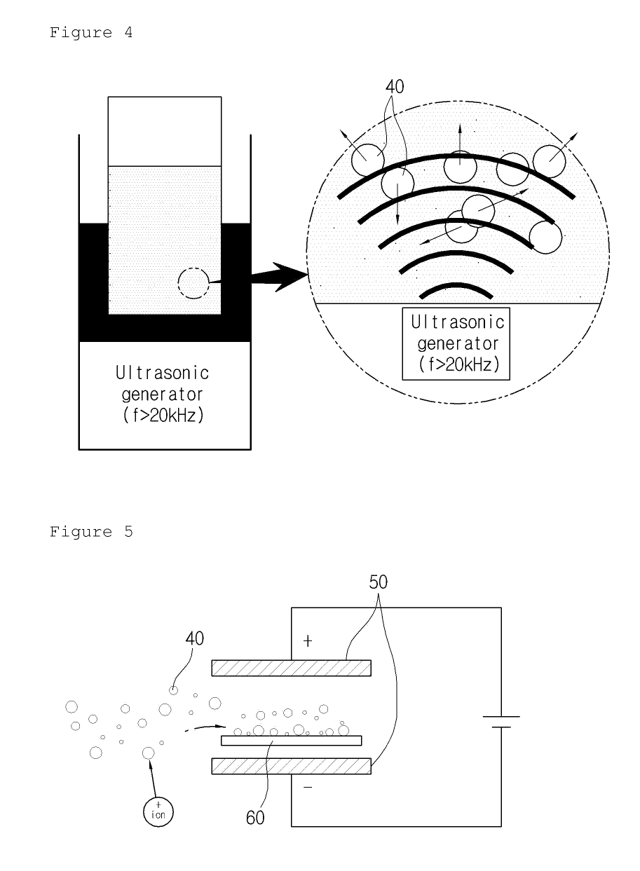

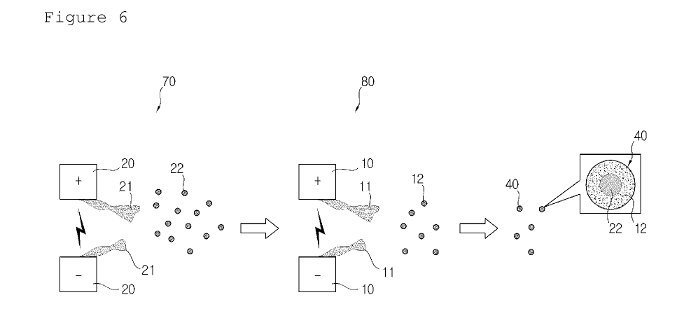

FIG. 1 is a schematic view of the spark generation step and the carbon nanostructure generation step illustrated in FIG. 1, FIG. 2 is a schematic view of the spark generation step and the carbon nanostructure generation step illustrated in FIG. 1, FIGS. 3a to 3c are cross-sectional views of the carbon nanostructures synthesized according to the method illustrated in FIG. 1, FIG. 4 is a schematic view of an embodiment of the aggregate separation step illustrated in FIG. 1, FIG. 5 is a schematic view of an embodiment of the collection step illustrated in FIG. 1 and FIG. 6 is a schematic view of another embodiment of the spark generation step illustrated in FIG. 1.

The present invention relates to a method for the synthesis of carbon nanostructures under normal pressure, that is, atmospheric pressure, by which carbon nanostructures are generated in aerosol state between a graphite electrode made of carbon (C) and a metal electrode made of a catalytic metal inducing the graphitization of carbon through spark generation.

Hereinafter, a detailed description of the method for the synthesis of carbon nanostructures under atmospheric pressure according to an embodiment of the present invention will be given below, referring to FIGS. 1 to 5.

First, as illustrated in FIG. 2, a spark 30 is generated between a graphite electrode 10 made of carbon (C) and a metal electrode 20 made of a catalytic metal inducing the graphitization of carbon. Then, the carbon component of the graphite electrode 10 and the metal component of the metal electrode 20 are vaporized by the heat produced by the spark 30 to form a carbon vapor 11 and a metal vapor 21, respectively (S110).

The carbon vapor 11 and the metal vapor 21 may be cooled and condensed as they are transferred to the region much colder than where the spark 30 is generated.

That is to say, following the spark generation step S110, the carbon vapor 11 and the metal vapor 21 are cooled and condensed due to the low ambient temperature to form a graphitic carbon layer 12 and catalytic metal particles 22. In the process, the graphitic carbon layer 12 grows on the surface of the catalytic metal particles 22 and forms carbon nanostructures 40 which cover the catalytic metal particles 22, as illustrated in FIG. 2 (S120).

In the described carbon nanostructure generation step S120, the carbon vapor 11 and the catalytic metal particles 22 exist together at the same place while the carbon vapor 11 and the metal vapor 12 vaporized by the spark generation are condensed and the graphitic carbon layer 12 grows on the surface of the catalytic metal particles 22 into the carbon nanostructures 40.

The catalytic metal particles 22 induce the graphitization of the carbon vapor 11, that is, the formation of the graphitic carbon layer 12, while the carbon vapor 11 is condensed and formed into particles. A characteristic graphite fringe appears at the site where the graphitization occurs.

As illustrated in FIG. 2, the carbon nanostructures 40 may exist as individual particles (A) or as aggregates (B) which are formed as the individual particles coagulate with one another.

In other words, the present invention relates to a method for the synthesis of carbon nanostructures using the spark generation between two different electrodes, precisely the graphite electrode 10 and the metal electrode 20. When a spark 30 is generated between the graphite electrode 10 and the metal electrode 20 by applying a high voltage between the electrodes, the carbon vapor 11 and the metal vapor 21 are formed. The carbon nanostructures 40 are formed as the two vapors are condensed and converted to the graphite carbon layer 12 and the catalytic metal particles 22, respectively.

The spacing between the graphite electrode 10 and the metal electrode 20 may be from 0.5 mm to 10 mm. For example, if the spacing is 1 mm, a heat of about 5000° C. is generated when a high voltage of 2.0 kV to 10.0 kV is applied. The carbon vapor 11 generated at the graphite electrode 10 and the metal vapor 21 generated at the metal electrode 20 are condensed and converted to the graphitic carbon layer 12 and the catalytic metal particles 22, respectively, and the carbon nanostructures 40 are formed in the process.

The high voltage power applied between the electrodes may be used either a direct voltage or an alternating voltage. When an alternating voltage is used, it may be used such as a square wave, triangular wave, offset-controlled source, etc.

The catalytic metal comprised in the metal electrode 20 may be a transition metal such as nickel (Ni), iron (Fe), cobalt (Co), silver (Ag), copper (Cu), titanium (Ti), etc., a noble metal such as palladium (Pd), platinum (Pt), gold (Au), etc. or a combination thereof. Obviously, various metals that do not belonging to the transition metal or noble metal or those not listed above may be used.

And, as illustrated in FIG. 6, the spark generation step S110 may be carried out by sequentially aligning a first generation unit 70 which generates a spark generation at the metal electrode 20 and a second generation unit 80 which generates a spark at the carbon electrode 10, in order to improve the synthesis yield of the carbon nanostructures 40. In that case, the catalytic metal particles 22 are generated first and then the carbon vapor 11 is formed. As a result, subsequently, the graphitic carbon layer 12 is formed on the surface of the catalytic metal particles 22.

For example, the sequential spark generation can be carried out as follows. In the first generation unit 70, the metal electrodes 20 is used as both the (+) and (−) electrodes. The electrons produced by the spark generation move and collide with the (+) metal electrode 20. Then, the metal vapor 21 vaporized from the metal electrode 20 by the heat resulting form the collision is condensed to form the catalytic metal particles 22 (S111).

And, the graphite electrode 10 is used as both the (+) and (−) electrodes of the second generation unit 80. As at the first generation unit 70, the carbon vapor 11 vaporized from the graphite electrode 10 by the spark generation is condensed on the surface of the catalytic metal particles 22, which are generated at the first generation unit 70 and carried to the second generation unit 80, to form the graphitic carbon layer 12. The graphitic carbon layer 12 grows into the carbon nanostructures 40 (S112).

This sequential spark generation steps S111 and S112, in which the catalytic metal particles 22 generated at the first generation unit 70 are carried to the second generation unit 80 and the carbon vapor 11 generated at the second discharge unit 80 by the spark adheres to the catalytic metal particles 22 carried to the second generation unit 80 and is condensed, can provide improved synthesis yield of the carbon nanostructures 40.

FIGS. 3a to 3c show various structures of the carbon nanostructures 40 formed as individual particles A.

FIG. 3a shows the carbon nano onion (CNO) structure, in which the graphitic carbon layer 12 comprising of carbon particles encircles the catalytic metal particles 22 like an onion. FIG. 3b shows the graphite strands formed of the graphitic carbon layer 12 surround the surface of the catalytic metal particles 22 with a plurality of layers, as the graphite strands do not get heat stress enough to emerge to the surface of the catalytic metal particles 22. The heat stress may result from the heat caused by the spark and the low ambient temperature.

The structure illustrated in FIG. 3c is attained when the graphitic carbon layer 12 emerges to the catalytic metal particles 22 due to the heat stress. Various forms including carbon nanorod (CNR), carbon nanotube (CNT), carbon nanofiber (CNF) and carbon nanoribbon may be attained.

The carbon nanotube (CNT) is attained when two opposing graphite strands grow to the surface of the catalytic metal particles 22. There is a void between the two graphite strands.

And, the carbon nanorod, the carbon nanofiber and the carbon nanoribbon are attained when a single graphite strand grows to the surface of the catalytic metal particles 22 by heat stress. The carbon nanorod is attained when the graphite strand grows straightly and the carbon nanofiber and the carbon nanoribbon are attained when the graphite strand grows windingly. The degree of winding is stronger for the carbon nanoribbon than the carbon nanofiber.

The afore-mentioned various structures of the carbon nanostructures illustrated in FIGS. 3a-3c are well known in the art and will not be further described here.

In the carbon nanostructure generation step S120, a process of separation may be necessary if the individual particles (A) of the carbon nanostructures 40 coagulate with one another in the form of aggregate or agglomerate (B), as illustrated in FIG. 2.

That is, the method for the synthesis of carbon nanostructures under atmospheric pressure according to the present invention may further comprise an aggregate separation step S130.

In the aggregate separation step S130, the aggregates (B) may be separated into the individual particles (A) by one or more of the followings: injecting high-pressure gas to the aggregates (B); treating the aggregates (B) with a surfactant to weaken the tension force between the aggregated individual particles (A); or applying an ultrasonic wave of a specific frequency to the aggregates (B) as illustrated in FIG. 4.

And, the method for the synthesis of carbon nanostructures under atmospheric pressure according to the present invention may further comprise a pure carbon nanostructure extraction step S140 of treating the carbon nanostructures 40 with ultrasonic wave as described above or acid solution so as to separate the catalytic metal particles 22 included in the carbon nanostructures 40 and obtain pure carbon nanostructure.

That is, the catalytic metal particles 22 are present inside the carbon nanostructures 40 prepared according to the present invention. In case pure carbon nanostructures 40 without including the catalytic metal particles 22, the catalytic metal particles 22 may be separated from the carbon nanostructures 40 through ultrasonic wave or acid solution treatment and obtain pure carbon nanostructures. Thus-obtained pure carbon nanostructures may be combined with new matter particles to be used as new material.

The pure carbon nanostructure extraction step S140 may be carried out following the carbon nanostructure generation step S120 or following the aggregate separation step S130. In other words, the step S140 may be carried out at any stage as long as the carbon nanostructures in which the graphitic carbon layer 12 surrounds the catalytic metal particles 22 are prepared.

Obviously, the efficiency of each of the aggregate separation step S130 and the pure carbon nanostructure extraction step S140 may be adjusted by changing the frequency of the ultrasonic wave, time duration of the ultrasonification, etc.

Following the carbon nanostructure generation step S120, the method for the synthesis of carbon nanostructures under atmospheric pressure according to the present invention may further comprise a transfer step S150 of carrying the carbon nanostructures 40 along the flow of a carrier gas, which is an inert gas or nitrogen (N₂), supplied between the graphite electrode 10 and the metal electrode 20 and a collection step S160 of collecting the carbon nanostructures 40 with a collector. The collector may be a substrate utilized in the manufacture of various devices.

The transfer step S150 and the collection step S160 may be carried out following the aggregate separation step S130.

The inert gas may be argon (Ar), helium (He), neon (Ne), krypton (Kr), xenon (Xe), radon (Ra), etc. The inert gas or nitrogen is very stable and hardly reacts with other ambient elements. Therefore, it can stably carry the carbon nanostructures 40. Also, the size of the carbon nanostructures 40 after condensation may be changed by the flow rate or flow volume of the carrier gas.

The collection step S160 may be carried out variously as exemplified by the following embodiments.

In a first embodiment, the carbon nanostructures 40 are carried along the flow of the inert gas or nitrogen are collected by colliding them at the collector. The carbon nanostructures may collide spontaneously as they are carried by the inert gas or nitrogen. Alternatively, an external force may be applied to facilitate the collision.

In a second embodiment, the carbon nanostructures 40 are transferred to the collector and collected there by thermophoresis using the temperature gradient between the carbon nanostructures 40 and the collector. That is, the temperature of the collector is maintained lower than the temperature of the carbon nanostructures 40 using a thermostat (not illustrated) so as to cause the carbon nanostructures 40 to move to the collector by the thermophoresis effect.

In a third embodiment, an electric field formed between two oppositely charged, parallel electrode plates 50 is utilized, as illustrated in FIG. 5. After charging the carbon nanostructures 40 positively or negatively, the carbon nanostructures 40 are moved to a collector 60 positioned between two electrode plates 50, which are charged positively and negatively, respectively. Then, the carbon nanostructures 40 are pulled by one of the electrode plates and fixed at the surface of the collector 60 by electrical attraction

As described, the carbon nanostructures are generated in dry aerosol state and may be transferred and collected easily. Therefore, the present invention is environment friendly with no generation of wastewater or hazardous substances.

And, because a liquid-phase chemical process or a critical reaction condition is not necessarily required for the generation of the carbon nanostructures, the carbon nanostructures can be synthesized with less energy consumption through a simple process. Further, the properties of the nanoparticles generation can be easily controlled.

In addition, the method of the present invention can be applied not only to the synthesis of mono-component nanoparticles but also to the synthesis of multi-component composite particles. Also, it can be combined with the conventional carbon nanostructure synthesis processes, such as arc discharge, catalytic chemical vapor deposition (CCVD), flame synthesis, laser ablation, etc., in order to improve the conventional processes.

And, since the carbon nanostructures 40 are generated electrically, for example, by spark generation, the method of the present invention provides easiness of control of the nanoparticles generation and is adequate for system automation.

In the described embodiment of the present invention, the carbon nanostructures 40 are generated by spark generation. However, it is obvious that the carbon nanostructures may be generated by heating a carbon source material (which may be a liquid) and a catalytic metal source material (which may be a liquid) using a hot source, such as a hot furnace, and condensing the resulting carbon vapor and catalytic metal vapor.

The method for the synthesis of carbon nanostructures according to the present invention provides the following advantages. Because the carbon nanostructures are formed in dry aerosol state, the produced carbon nanostructures can be delivered and collected easily. Further, the method is environment-friendly with no generation of wastewater. In addition, the electrical generation (spark generation) of the carbon nanostructures enables an easy control of nanoparticles generation and is adequate for system automation.

Further, in case the generated carbon nanostructures exist as aggregates, they can be converted to individual particles through a separate separation process. The pure carbon nanostructures are obtained by separating the catalytic metal particles from the carbon nanostructures may be combined with new matter particles to be used as new material.

Obviously, numerous modifications and variations of the present invention are possible in light of the above teachings. It is therefore to be understood that within the scope of the appended claims, the invention may be practiced otherwise than as specifically described herein.

1. A method for the synthesis of carbon nanostructures under atmospheric pressure comprising a spark generation step of
generating a spark between a graphite electrode made of carbon and a metal electrode made of a catalytic metal inducing the graphitization of carbon and vaporizing the carbon component of the graphite electrode and the metal component of the metal electrode utilizing the heat produced by the spark, thereby generating carbon vapor and metal vapor; and
a carbon nanostructure generation step of cooling and condensing the carbon vapor and the metal vapor to form a graphitic carbon layer and catalytic metal particles and generating carbon nanostructures in which the graphitic carbon layer grows on the surface of the catalytic metal particles and covers the catalytic metal particles.

2. The method for the synthesis of carbon nanostructures under atmospheric pressure as claimed in claim 1, which further comprises
an aggregate separation step of separating aggregates into individual carbon nanostructures utilizing one or more of high-pressure gas injection, surfactant treatment and ultrasonification,
when the carbon nanostructures are formed as aggregates,

3. The method for the synthesis of carbon nanostructures under atmospheric pressure as claimed in claim 2, which further comprises
a pure carbon nanostructure extraction step of separating the catalytic metal particles included in the carbon nanostructures by treating with ultrasonic wave or acidic solution.

4. The method for the synthesis of carbon nanostructures under atmospheric pressure as claimed in claim 1, which further comprise
a transfer step of carrying the carbon nanostructure along the flow of an inert gas or nitrogen; and
a collection step of collecting the carbon nanostructure at a collector,
wherein the collection step is carried out by simply colliding the carbon nanostructures carried along the flow of the inert gas or nitrogen at the collector; inducing the carbon nanostructures to move to a collector and fix there by thermophoresis using the temperature gradient between the carbon nanostructures and the collector; or after charging the carbon nanostructures positively or negatively, moving the carbon nanostructures to a collector positioned between two oppositely charged electrode plates, so that the carbon nanostructures are pulled by one of the electrode plates and fixed at the collector by electrical attraction.

5. The method for the synthesis of carbon nanostructures under atmospheric pressure as claimed in claim 1, wherein the spark generation step is carried out sequentially by
a first generation step of generating spark at the metal electrode; and
a second generation step of generating spark at the graphite electrode.

6. The method for the synthesis of carbon nanostructures under atmospheric pressure as claimed in claim 1, wherein the catalytic metal is one or more of nickel (Ni), iron (Fe), cobalt (Co), silver (Ag), copper (Cu), titanium (Ti), palladium (Pd), platinum (Pt) and gold (Au).

7. The method for the synthesis of carbon nanostructures under atmospheric pressure as claimed in claim 1, which further comprises
a pure carbon nanostructure extraction step of separating the catalytic metal particles included in the carbon nanostructures by treating with ultrasonic wave or acidic solution.
